(19) United States
(12) Patent Application Publication
(10) Pub. No.: US 2013/0310154 A1
(43) Pub. Date: Nov. 21, 2013

(54) SOLITAIRE-STYLE ELECTRONIC GAME OF CHANCE

(71) Applicant: Score Gaming LLC, Los Angeles, CA (US)

(72) Inventor: Merrill Sparago, Los Angeles, CA (US)

(73) Assignee: Score Gaming LLC, Los Angeles, CA (US)

(21) Appl. No.: 13/894,544

(22) Filed: May 15, 2013

Related U.S. Application Data
(60) Provisional application No. 61/646,952, filed on May 15, 2012.

(51) Int. Cl. G07F 17/32

(52) U.S. Cl. CPC G07F 17/3286; G07F 17/32
USPC 463/25

(57) ABSTRACT

An electronic wagering game adapting any style of solitaire to a slot machine type format. An electronic representation of a standard deck of fifty-two playing cards is used to deal an initial hand of twenty-eight Tableau cards and twenty-four Side Cards. The Tableau cards are placed into seven columns according to the traditional manner. The player plays the initial hand according to the rules of the particular style of solitaire, for example Klondike-style, and is awarded credits, bonus games or other tokens of a value if at least one exposed card matches a predetermined criteria.

### CROSS REFERENCE TO RELATED APPLICATIONS

This application claims priority to Provisional Patent Application No. 61/646,952 filed May 15, 2012, the entire disclosure of which is hereby incorporated by reference and relied upon.

### BACKGROUND OF THE INVENTION

1. Field of the Invention

The current invention relates to a method for playing a card game, and more particularly to a method of playing a solitaire-style game on an electronic machine with one or more bonus options.

2. Related Art

Games that require a blend of luck and skill are popular in the casino industry, and have experienced successful transition to modern electronic gaming platforms. As examples, versions. of blackjack and poker which have been adapted to the slot machine venue. In draw poker, for example, the player is dealt an original 5 card poker hand, but can select several cards to be replaced for new cards if they do not make a suitable poker hand. The player uses strategy to decide which cards to keep and which to discard hoping that they will draw cards that will make a better hand. Despite a player's skill level, it takes an added bit of luck to win as the machine's pay out system always includes a house advantage.

Solitaire is one of the most popular card games worldwide. The method of play is well known, thus making it adaptable to be played in a slot machine. Solitaire is similar to blackjack and poker in that there is a certain skill level one can master however in order to win the game the player must be lucky enough to receive cards in the correct order that allow play to continue. Though an exact figure is difficult to calculate the odds of winning a solitaire game are approximately 9%.

Even though solitaire is a very popular card game, it has not made a successful transition to modern electronic gaming platforms in the casino environment. Solitaire's lackluster penetration of the casino gaming environment is due at least in part to the game's limited ability to provide excitement, strategy, and bonuses. Essentially, in solitaire a player either wins or loses. Several variations of traditional solitaire have been invented to increase excitement but have none been successfully adapted for play on in wagering platforms.

What is needed is an exciting and fun addition to solitaire which both enhances the game and makes it more suitable for the gaming industry by making it playable on a slot machine or other interactive format.

### SUMMARY OF THE INVENTION

An electronically implemented method of playing a wagering game based on one of the traditional forms of solitaire using images of playing cards. The method steps include providing an electronic gaming machine including at least one display screen configured to display images of playing cards. The electronic gaming machine includes a non-transitory computer readable medium coded with instructions and executed by a processor to perform the following steps: providing electronically producible images of at least one standard deck of fifty-two playing cards with respective faces designated in ascending numerical sum 2-10, J, Q, K. A each in four suits, accepting a primary wager from the player, randomizing the deck of cards, dealing the player an initial hand from the randomized deck of cards consisting essentially of some Tableau cards and the remainder Side Cards, exposing some of the Tableau cards while all other cards in the Tableau are face-down, placing the Side Cards face-down in a stack, interacting, with the player to play the initial hand according to the rules of solitaire in which at least some of the Tableau cards and sonic of the Side Cards are exposed while attempting to place all cards in numerically ascending and suited columns in a Foundations area of the display screen, and awarding the player a value if at least one exposed card matches a predetermined criteria.

The invention also contemplates a solitaire gaming system comprising at least one input device, at least one display device, at least one processor, and at least one memory device storing a plurality of instructions which when executed by the at least one processor cause the at least one processor to operate with the at least one input device and the at least one display device for a play of a solitaire game using, cards to: provide electronically producible images of at least one standard deck of fifty-two playing cards with respective faces designated in ascending numerical sum 2-10, J, Q, K. A each in four suits, accept a primary wager from the player, randomize the deck of cards, deal the player an initial hand from the randomized deck of cards consisting essentially of some Tableau cards and the remainder Side Cards, expose some of the Tableau cards while all other cards in the Tableau are face-down, place the Side Cards face-down in a stack, interact with the player to play the initial hand according to the rules of solitaire in which at least some of the Tableau cards and some of the Side Cards are exposed while attempting to place all cards in numerically ascending and suited columns in a Foundations area of the display screen, and award the player a value if at least one exposed card matches a predetermined criteria.

The invention provides a unique method of adapting solitaire to a viable casino format by combining, the play of the game with features of slot machines that allow for distribution of cards as well as methods to pay bonus hands through integrating solitaire with poker and/or blackjack. These variations and improvement enable a new level of player strategy and skill in the game as well as novel optional bonus rounds.

### BRIEF DESCRIPTION OF THE DRAWINGS

These and other features and advantages of the present invention will become more readily appreciated when considered in connection with the following detailed description and appended drawings, wherein:

FIG. 1 is an exemplary depiction of a slot-based gaming machine configured to play the game of the present invention;

FIG. 2 describes the layout and arrangement of cards according to the present game;

FIGS. 3-8 depict an exemplary hands at various sequence of action illustrating features of the present game;

FIG. 9 is an exemplary flow chart depicting play of the game;

FIG. 10 is an exemplary flow chart depicting an optional bonus round in the game;

FIG. 11 is an exemplary depiction of Magic Cards and a predefined sequence selected by the computer;

FIG. 12 is an exemplary depiction of seven Magic Cards and a predefined sequence selected by the computer; and

FIG. 13 is an exemplary depiction of nine Magic Cards and a predefined sequence selected by the computer.

### DETAILED DESCRIPTION OF THE PREFERRED EMBODIMENT

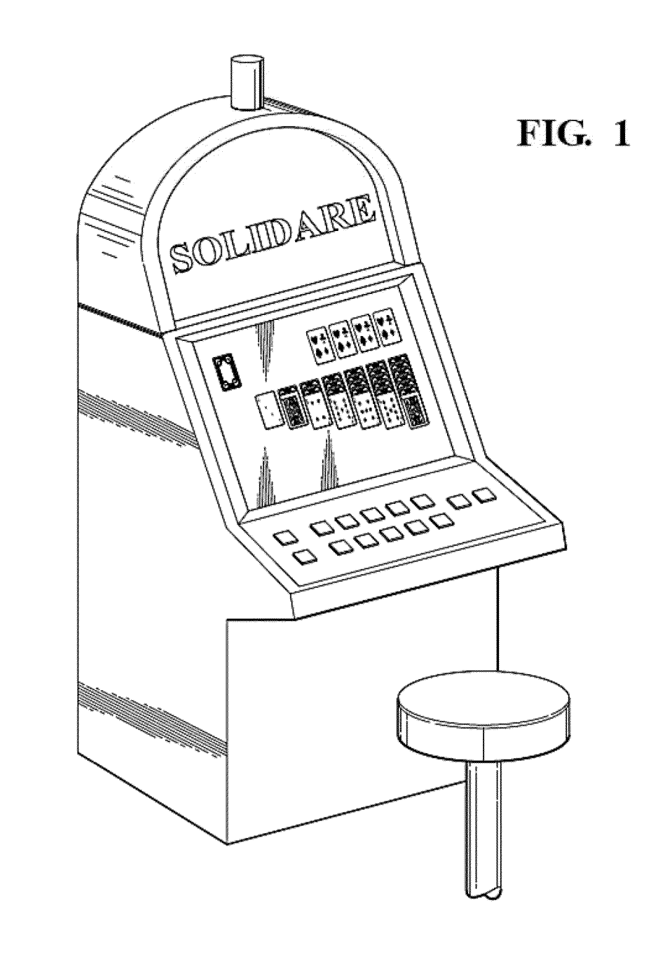

The novel solitaire card game variation henceforth referred to as the “game”, but which may also sometimes be referred to by the proprietary trade name “Solidare™”, is preferably played on an electronic or computerized gaming console consistent with the general architecture of a slot or gaming machine. (See FIG. 1.) Of course, other electronic implementations may also be used including, but not limited to, hand-held and mobile devices. PC's, tablets, and the like.

The gaming machine is provided with a non-transitory computer readable medium coded with instructions and executed by a processor to perform the steps of the game method as described herein. This would, in general, include a gaming console equipped with a specified place for a player to insert money or other forms of currency/credit in the form of a card, and otherwise register a wager. The gaming console preferably includes a video screen to depict an animated version of cards, and a designated area/button for the player to trigger the computer to deal the initial hand of cards or dispense cards in groups of three after the player has made all of the moves they can from the initial cards that were dealt.

The non-transitory electronic/computerized medium deals and distributes the cards. according to the traditional rules and dealing procedures in solitaire. The specific solitaire game rules may follow that of the well-known Klondike-style, or such variants as Pyramid, Golf, Yukon, Poker, Accordion, Canfield, Good Measure, Baker's Dozen. Spider or the like. For convenience, the following description will be based on Klondike-style solitaire; it being understood that with minimal adaption the principles of this invention can be applied to any of the other forms of solitaire. An interactive touch screen may display a visual simulation of cards for the player. Players can use the touch screen to move and manipulate cards.

The computer processor and coded instructions will randomize a virtual representation of a standard single deck of fifty two playing cards excluding jokers. The player makes an initial wager to begin the play of the game. The amount of the wager as well as all further wagers and payouts described herein will be determined through mathematical analysis to provide a house edge consistent with that standard to the gaining industry of otherwise implemented by the gaming establishment.

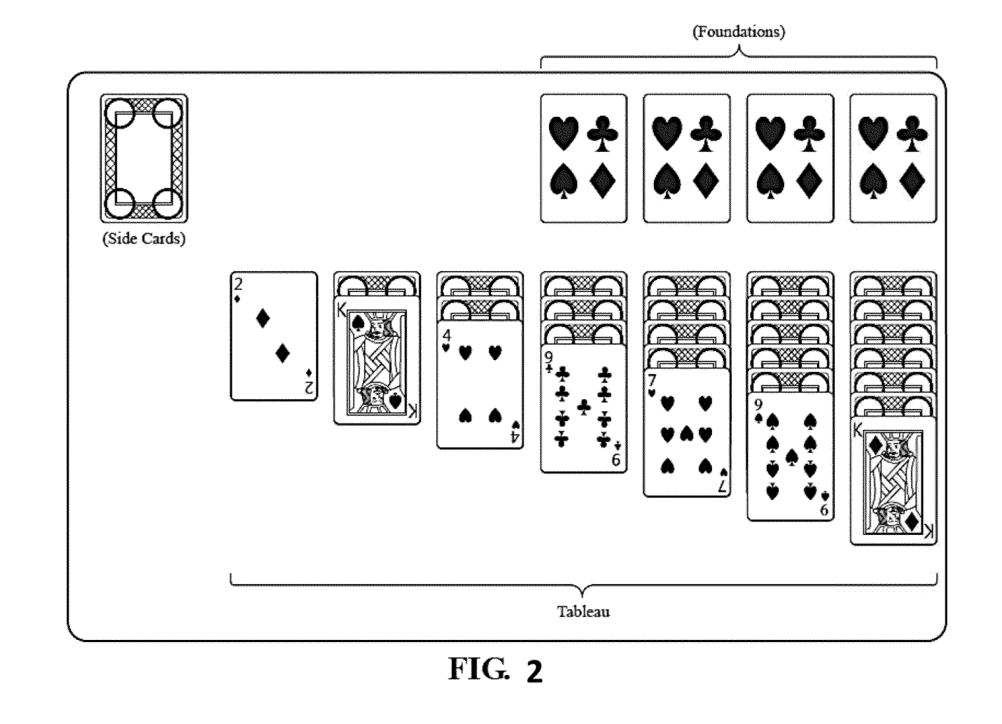

Once a wager has been placed the game hand will be dealt per the traditional rules of solitaire. An example of an initial dealt hand is shown in FIG. 2. The present card game is played with a virtual deck of 52 standard playing cards, Thirteen cards (Ace-King) in four suits diamonds, hearts, clubs, spades) are used to comprise the 52 card deck. Jokers are not used in the base game but may be used in the bonus round which is played and described separately from the play of game.

To begin the game the player must insert money or establish credits through computer readable cards or other mechanisms available to establish credits in gaming machines to deal the cards. The present game is ideally suited for play in a penny slot format, whereby distribution of the cards is triggered after a fixed number of credits are inserted or deducted from the player's credit account. Of course, the game is not limited to penny-slot platforms. Nevertheless, the penny slot version attracts players that are familiar with solitaire and allows for the player to play the game with a smaller bankroll. Thus in one exemplary version, 50 credits are required to start the game, which would translate into $.50 for the player on a penny slot. Higher credit denominations can be used as well, whereby a credit per penny is an exemplary suggestion for play of the game.

After the player has placed the required number of credits in the machine, the computer will randomize the cards, preselect Magic Cards (described below) if present in the play of the game and deal the game in the same manner as the selected type of solitaire is dealt. As mentioned above, the following description is based on Klondike-style solitaire, although those of sill in this art will appreciate that the principles of this invention can be applied to any of the other forms of solitaire. Play begins with the computer exposing one card and the dealing six cards face down on the same horizontal row as the first exposed card thereby creating seven columns of cards. After these first seven cards are dealt, the computer deals a second exposed card on the unexposed card immediately to the right of the first exposed card (i.e. in the second column) which then contains two cards one exposed card sitting atop one unexposed card. The computer then deals one unexposed card on each card across the same horizontal row until all cards in each column have a second unexposed card. This process is repeated until all cards have a single exposed card whereby each column will have the same number of cards each with one exposed card atop the unexposed card, as shown in FIG. 2. This is known as the “Tableau” section of the game layout.

As such, when this dealing procedure is completed the initial Tableau section may be defined as the column on the player's far left (Column 1) one exposed card; Column 2 having one unexposed card with a single exposed card on top on the unexposed cards, thereby making a stack of 2 cards; Column 3 having 2 unexposed cards with a single exposed card on top on the unexposed cards, thereby making a stack of 3 cards; Column 4 having 3 unexposed cards with a single exposed card on top on the unexposed cards, thereby making a stack of 4 cards; Column 5 having 4 unexposed cards with a single exposed card on top on the unexposed cards, thereby making a stack of 5 cards; Column 6 having 5 unexposed cards with a single exposed card on top on the unexposed cards, thereby making a stack of 6 cards; and Column 7 having 6 unexposed cards with a single exposed card on top on the unexposed card, thereby making a stack of 7 cards.

Game cards not used in the original hand are set aside in the order they were dealt to be used and played as per the traditional rules of solitaire. These initially unused remaining cards from the 52-card deck are known as “Side Cards” or the “Stock”.

After the computer has dealt all of the cards and placed the Side Cards (as shown in FIG. 2), play may begin as per the traditional rules of solitaire. The goal of the game is to rearrange the cards on the board such that a player can make 4 new stacks of cards, one per each suit starting with an Ace and then sequentially adding a card in the numerical order two through King until all 52 cards are rearranged into the new 4 stacks of cards. These will be referred to as “new stacks” for the purpose of simplifying this discussion. The new stacks are located in a Foundations region of the game layout, as shown in FIG. 2.

The player's initial goal is to rearrange the cards in each column by moving an exposed card underneath a card in another column. To move a card between columns the card being. moved must be of: 1) A different color (i.e. red cards as represented by the suits of diamonds or hearts as being a different color than black cards represented by the suits clubs and spades) and; 2) Of lower numeric ranking then the card in the column the card is being moved to with a King being the highest ranking followed by Queen, Jack, 10, and then descending in numerical order with the 2 being the lowest ranking.

When the player exposes an Ace either in the Tableau section or in the Side Cards, the Ace is placed in one of four spots on the game board comprising the Foundations section, with each spot representing a different One of each of the four suits. This area is traditionally located above and to the right of the columns of cards and represents the new stacks, although its specific location is not critical. The player then tries to place numerically ascending and like-suited cards from either the Tableau or Side Card sections on the Ace in the Foundations section such that each new stack will have the cards Ace through King in ascending order (i.e. inverse to the order of the cards arranged in the game board). To move a card to a new stack in the Foundations, that card must be a top card in a column that contains only a single exposed card or the final card in a column that contains multiple exposed cards or the top exposed card in the Side Cards. As such, if a player reveals an Ace of spades, the Ace can be moved to the separate designated space on the game board.

Once the Ace is moved to the designated spot, the only card that can be placed upon it is the 2-card of that same suit. That 2-card must have been either the final exposed card in a. column of multiple cards, or a single exposed card in a column of one card, or the playable card on the Side Cards. In order to further build this new stack, the player must endeavor to place the 3-card of the same suit upon the 2-card, and then using the same rules place the four-card of the same suit, and so on. This process is continued for each of the four suits,

The player will win a game by the same mechanism they would win a traditional game of solitaire. That is, the player wins the game if they are able to rearrange all 52 cards on the game board in four individual new stacks in the Foundations section. The rules of traditional solitaire are employed in the present game, and thus the player must obey all traditional rules to win the game. Short of this, a player will be considered as losing the game in terms of the overall. outcome of the play of the game. Of course this does not exclude winnings that are amassed during the play of the game, or winnings in bonus rounds as described below. Thus a unique feature of this invention is that under the right circumstances a player can lose the traditional game but still win monies or its equivalent in the form of credits through various bonus plays and strategic moves.

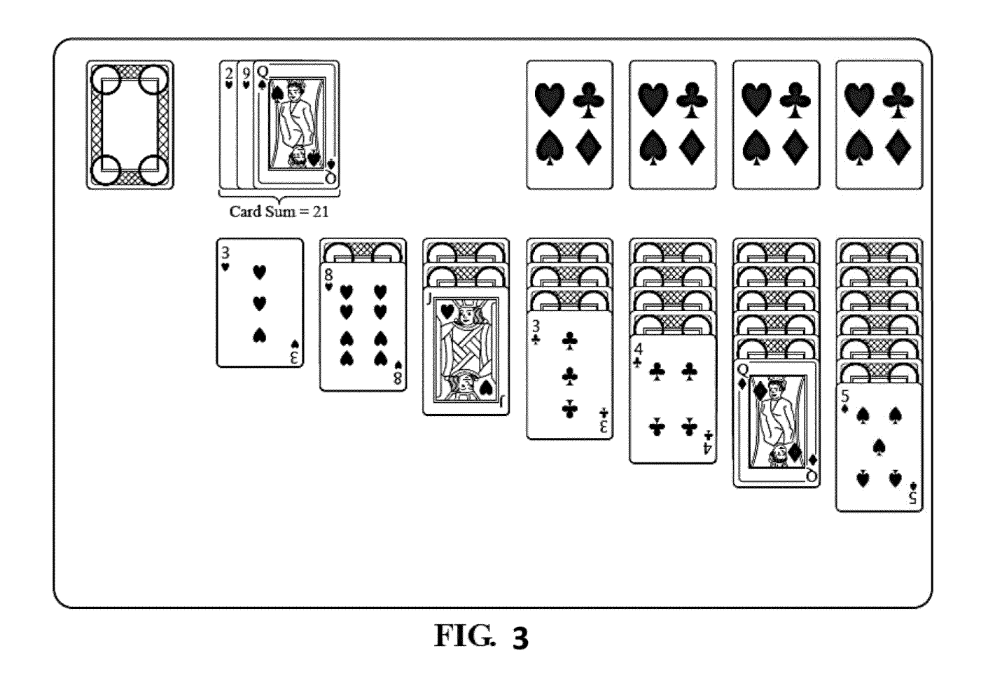

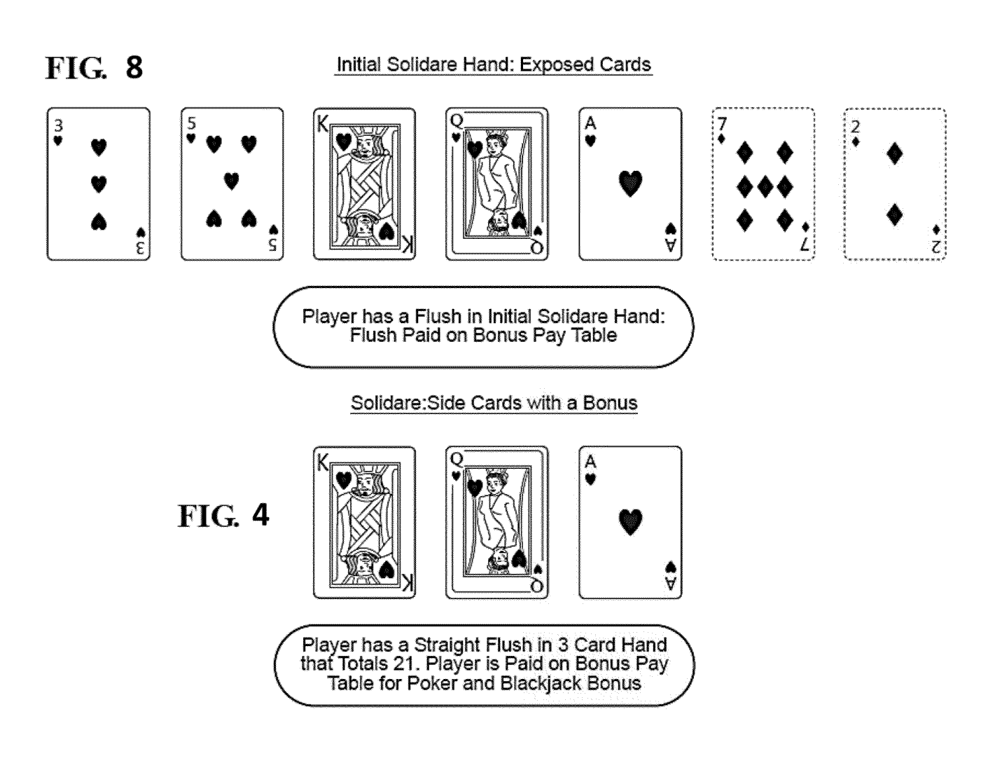

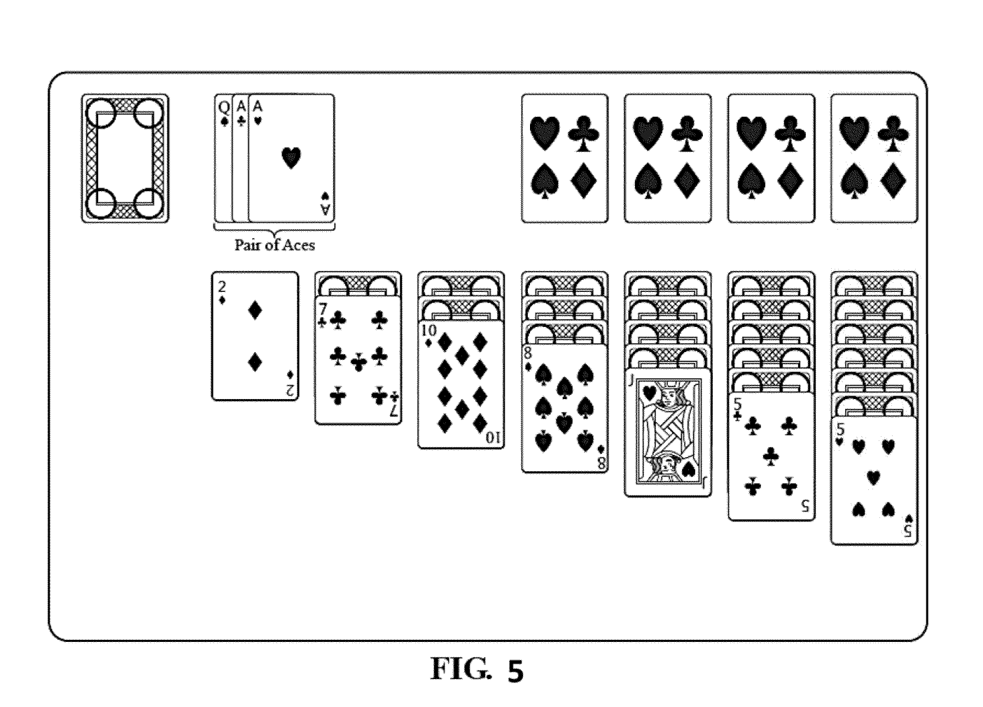

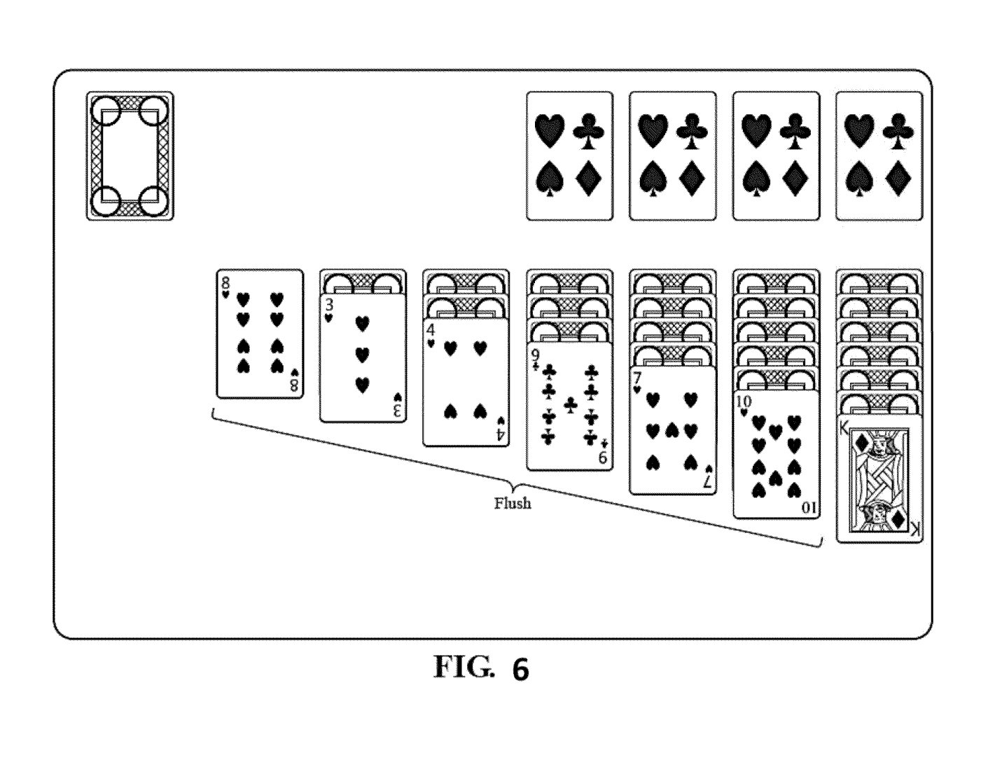

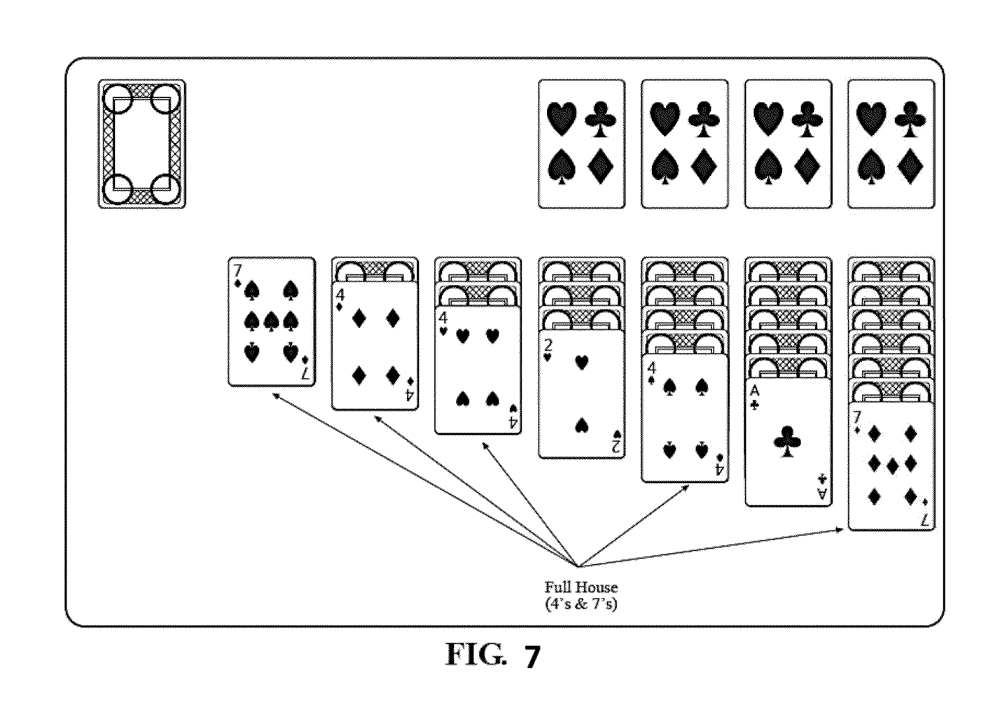

Bonuses can be established and paid in several fashions. In one example illustrated in FIG. 3, bonuses based on Side Card hands (i.e., three revealed Side Cards) having a combined sum total of 21. In this case all cards will have the standard rankings ascribed by the traditional rules of blackjack. Winning hands can be paid on a pay table with higher bonuses for hands that total 21 that contain a pair, three of a kind, a straight, a straight flush or a mini royal (i.e. Queen, King and Ace of the same suit, total=21, as shown in FIG. 4). This creates a hybrid pay table of blackjack and poker hands. In another example, bonuses may be based on Side Card hands that qualify strictly as poker hands. As shower in FIG. 5, the three Side Cards contain a Pair of Aces. Exposed cards in the Tableau section may also be considered, as in the examples of FIG. 6 (Flush) and FIG. 7 (Full House) and FIG. 8 (Flush). Winning hands may include a pair, straight, flush, straight flush or three of a kind. Winning hands can be paid against a pay table. The computer controller can be programmed to pay such Tableau poker-hand bonuses only on the initial deal or at any time during the course of play.

In another example, a bonus may be paid if the player is able to use three consecutive Side Cards by placing them on the game board (i.e., within either of the Foundations or Tableau sections). Bonuses may also be based on Magic Cards, which are described in detail below. In general, however, bonuses can be paid if a single or multiple Magic Cards are present in the three Side Cards. It is contemplated that the Magic Cards can represent many unique features including being used as a bonus multiplier. Thus a single Magic Card if present in a group of Side Cards can qualify for a bonus. In certain embodiments the set of three cards may need to contain a Magic Card to qualify for a poker hand to limit payouts and provide a sustainable house edge.

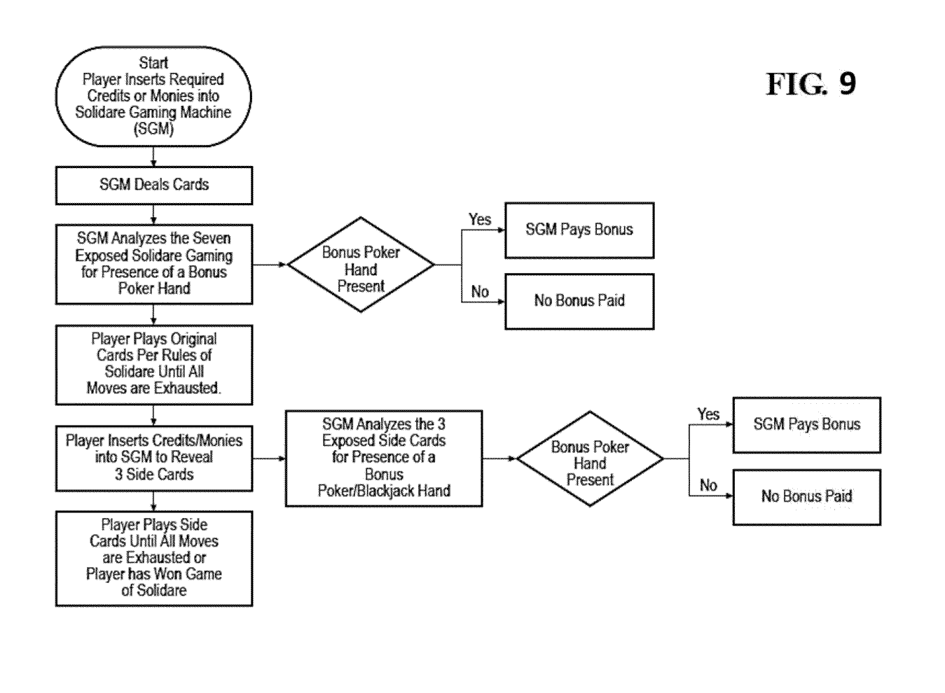

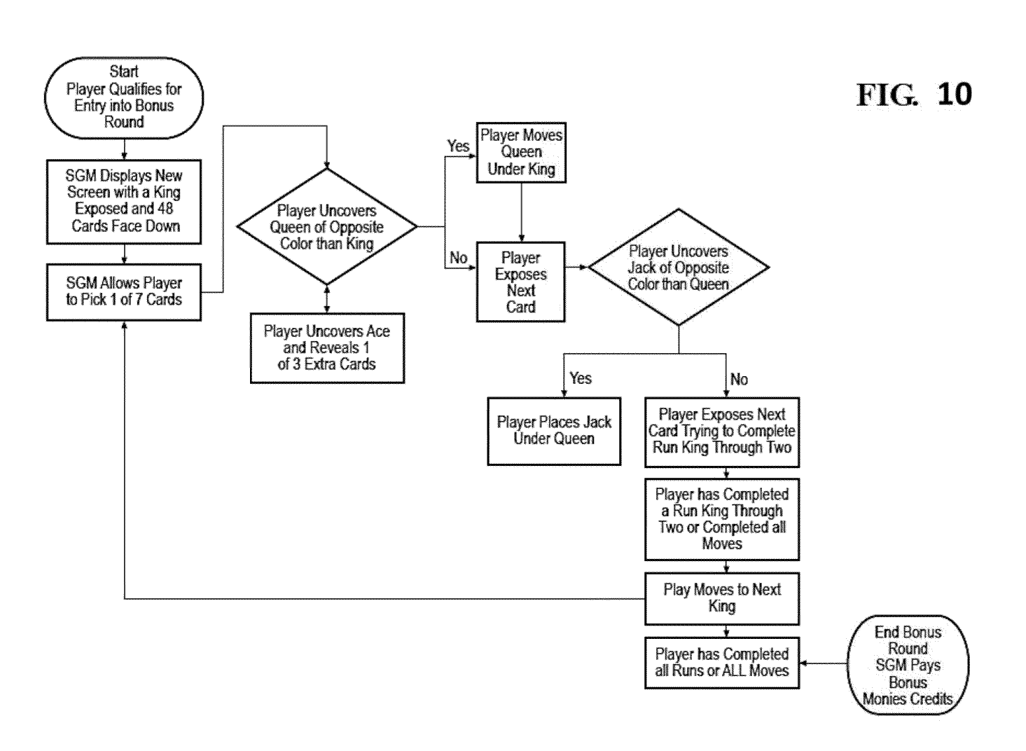

Flow charts describing the sequence of play are provided in FIGS. 9 and 10.

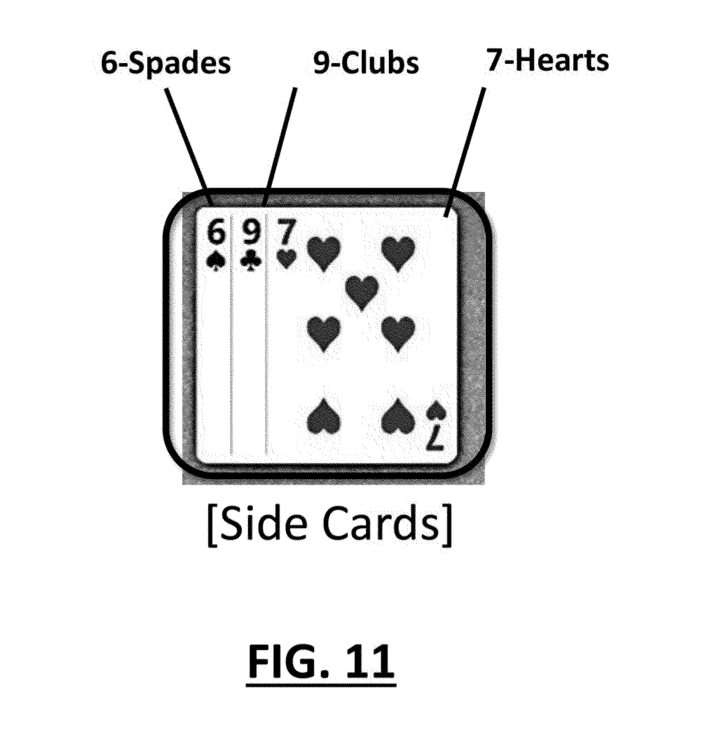

According to one embodiment of the invention, prior to the start of play the computerized controller will randomly select a predefined number of bonus cards referred to herein as “Magic Cards”. The Magic Cards are depicted in FIGS. 11-13. Of course, these bonus Magic Cards can be labeled with other names or distinguishing features provided their function remains consistent with the principles of this invention. The Magic Cards may have a plurality of functions in the play of the game. The Magic Cards can be randomly selected prior to randomizing the deck of 52 cards or after the deck is randomized.

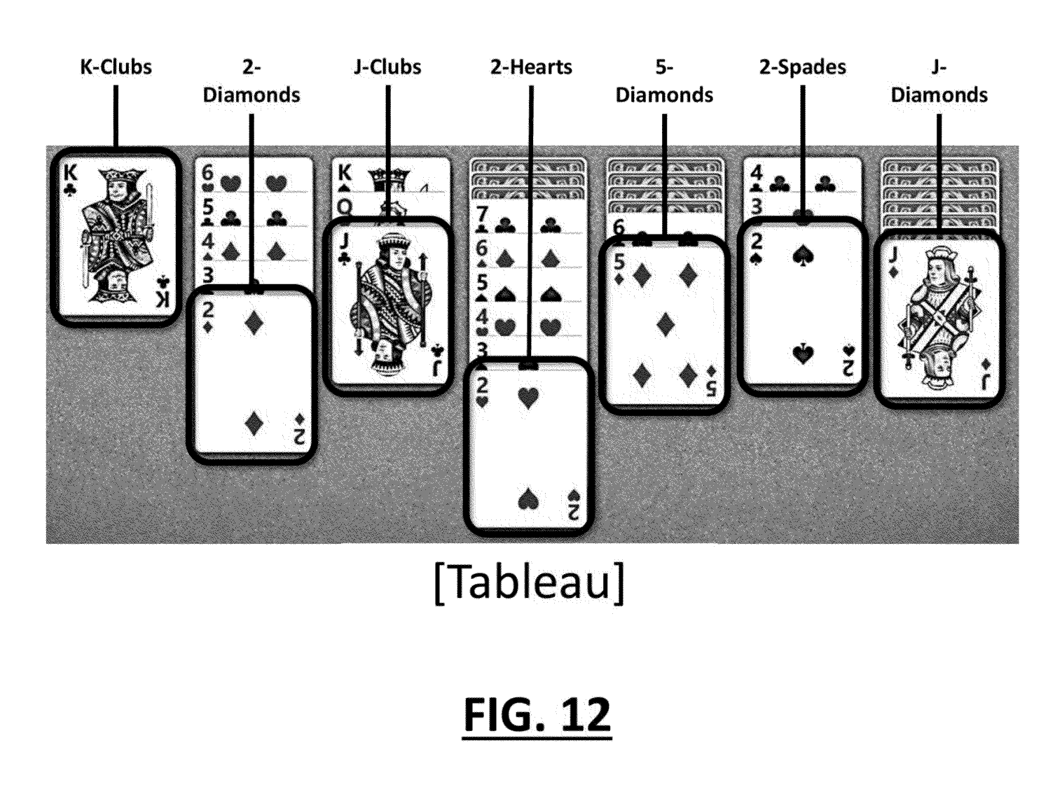

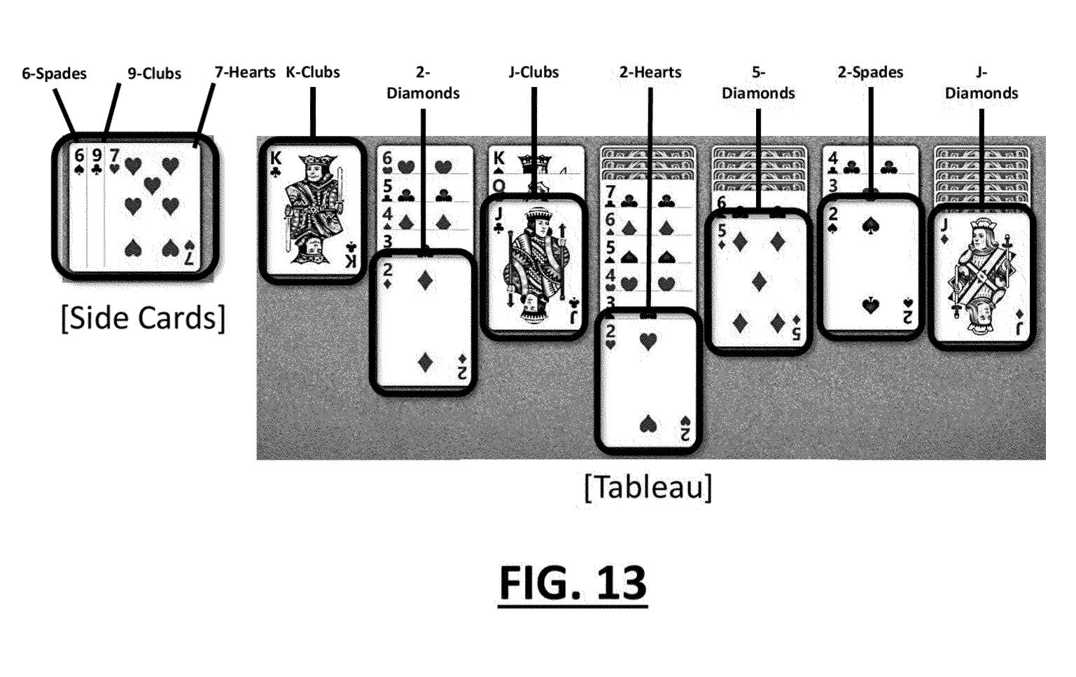

A proper mathematical analysis determines the frequency at which the random sequence of Magic Cards will appear. Based on the rare nature of the event happening, a large payout can be offered while maintaining a sustainable house edge. Inclusion of Magic Cards into the current invention allows for several denominations of jackpots to be paid. Jackpots or large denominations of winnings are important and common facets of slot machines. Accordingly the smallest jackpot can be paid if three of the Side Cards contain the Magic Cards in a pre-defined sequence, as illustrated for example in FIG. 11. A higher jackpot can be paid if the first seven cards exposed in the Tableau match the correct sequence of Magic Cards, depicted in FIG. 12. Alternatively, the highest jackpot can be developed by stringing together sets of Magic Cards such as nine which could be revealed through the combination of Side Cards and Tableau cards, like that shown in FIG. 13.

The identity of the Magic Cards will be unknown to the player until they are revealed throughout the course of play of a round of the modified game of solitaire. Magic Cards can be revealed to the player by several methods including: 1) Being exposed as one or more of the first seven visible cards that are dealt in the traditional method of the play of solitaire, 2) Being uncovered by moving cards in the play of the game, and/or 3) Being uncovered through the play of the Side Cards. When a Magic Card is revealed, the card will have a unique identifier which alerts the player it is indeed a Magic Card. Identifiers can be the words “Magic Card” or other phrases, or any other illustrative colors, shapes or icons that distinguish these bonus cards from non-Magic Cards. They can be further identified through the use of audio or other sensory indicators.

Therefore, Magic Cards are a grouping of random cards preselected by the computerized medium before any cards are dealt. Magic Cards are used in certain embodiments of the invention and absent in other embodiments. Further, altering the number of Magic Cards (from zero to fifty one) in a game can be used to differentiate alternative embodiments of the invention. In FIG. 12, an exemplary depiction of seven Magic Cards is depicted. If these seven cards appear on the playing screen in the exact order preselected by the computer (K-Clubs, 2-Diamonds, J-Clubs, 2-Hearts, 5-Diamonds, 2-Spades. J-Diamonds), the player will win a prescribed jackpot. FIG. 13 is a variation on the embodiment of FIG. 12 in which nine Magic Cards and a predefined sequence are selected by the computer. In this embodiment, the Magic Cards include the three Side Cards (6-Hearts. 9-Clubs and 7-Hearts). If all nine of these cards are present in the exact order preselected by the computer, the player will win a prescribed jackpot.

Moreover, the number of Magic Cards present in a game can be a function of the initial investment a player makes to start the game and/or dependent on the number of credits played on each turn of the Side Cards, whereby the higher the initial investment and/or the higher the wager a placed on the play of the Side Cards, the higher the number of Magic Cards in a game. In these embodiments predetermined mathematically derived ratios govern the relationship between player investment and number of Magic Cards. This concept is also novel as it gives the player influence on the number if Magic Cards they will have in play thereby increasing a sense of control through the play of the game.

Magic Cards are revealed throughout the standard course of play of the Tableau portion of the game and in general are not used in the play of the bonus round. However, uncovering Magic Cards in the course of the play of the game can be used to both trigger entrance into the bonus round, and/or determine the number of opportunities a player may get to win monies in a bonus round.

The presence of Magic Cards adds another layer of novelty and excitement to the game. They also provide for maintenance of a house edge as well as the opportunity to pay large bonuses. Accordingly, the house edge can be manipulated by restricting pay of bonuses to a Magic Card, as opposed to all cards, when they are reformed and placed on the stack of cards beginning, with an Ace as the player attempts to win the Tableau portion of the game per the traditional rules of solitaire.

By restricting payouts to Magic Cards, this serves the dual purpose of increasing excitement when the Magic Card is found while limiting return to the player (i.e. increasing the house edge). As an example, if a player were to be paid on every card they placed on the newly formed stacks of cards beginning with an Ace, then there would need to be 52 separate bonuses paid to the player in the course of completing the game. This pay structure could therefore alter the amount of return given to the player in the other portions of the game such as the bonuses that are paid: 1) For the first seven exposed cards upon the initial deal of the game; 2) Through the play of the Side Cards; 3) For uncovering winning combinations in the bonus round; and/or 4) in rare events that can be used to pay jackpots. With the option to limit payouts through the use of Magic Cards when cards are arranged into card stacks, more flexibility is built into other aspects of the game.

Magic cards and their play are distinguished from methods known in the play of games such as Keno. In Keno, a randomized predetermined number of objects are preselected from a larger group of objects and illuminated for the player to see. These objects are in general a set of numbers from 1-60 but could be any object such as letters, figurines, names or the like. To begin a game of Keno, players select their numbers and try to match the random numbers distributed from the Keno machine or electronic display. In general, the more numbers that match, the higher the bonus.

In the present game method, however, Magic Cards preselected by the computer are distinguished from the play of keno by such factors as: 1) A players winnings are not solely determined by the number of Magic Cards discovered; 2) Wagering in the game is not for the sole purpose of matching Magic Cards; 3) Magic cards are used the same way as regular cards. for the play of the game if solitaire; and 4) Magic cards can be used to pay bonuses just by being revealed by the player rather than being preselected by both the player and the computerized or other methods blown to Keno

Magic cards can be used to construct large payouts consistent with the general architecture of slot play. Accordingly, the computerized medium will also predefine a specific sequence of the random Magic Cards such that if the Magic Cards are revealed in that specific order a larger bonus such as a jackpot can be paid. This can refer to the first seven exposed cards and/or contiguous sets of Side Cards. As one example, there can be a preselected sequence of seven Magic Cards of say, 8-Clubs, 6-Diamonds, Q-Clubs, 5-Hearts, K-Diamonds, 3-Spades and 10-Diamonds. If on the initial deal of the game, each of these Magic Cards is placed in its correct order from left to right, the jackpot can be paid. There can be a second subset of any number of Magic Cards in this case 24, representing the 24 Side Cards that are played. In this case the computer would randomize the cards before selecting the Magic Cards as they are divided into those that will be dealt on the main board, and those that will remain as Side Cards. If the 24 Magic Cards match the same order as predetermined by the computer, then a jackpot is paid. The computerized game machine can be programmed to alert the player how many Magic Cards have been revealed in correct sequence and the aggregate payout thereby building excitement with each turn of the cards. Therefore, the game of this invention can be played with any predefined number of Magic Cards. Further the Magic Cards can be divided into subsets for different bonus payouts.

After the initial game hand is dealt the computer program analyzes the seven exposed cards in the Tableau portion of the game hand for the presence of Magic Cards, as well as for standard seven card poker hands and/or solitaire hands represented by a predefined number of alternating cards of different colors red cards (i.e. hearts and diamonds) and black cards (i.e. clubs and spades) whether in numerical sequence or not and paving, winning hands on the basis of a prescribed pay table. The pay table may include any and all combinations of Magic Cards, poker hands, solitaire hands or any combination of the three. Higher bonuses can be paid if the Magic Cards are exposed in the exact predefined order randomly selected by the computer medium before the game is played.

The computer program further allows the player to move their game cards per the traditional rules of solitaire until all moves are exhausted. Side Cards are preferably exposed in groups of three, taken from the top of the deck. In order to reveal the first and each successive group of three Side Cards, the player may be required to place a wager or otherwise add to their at-risk game credits. Players may expose the cards without placing an additional wager to play the main game, however the player may not be able to qualify for winning bonuses based on the composition of the three cards as described below. Qualification for bonuses without placing additional wagers will be a function of mathematical analysis.

The computer program analyzes each revealed group of three Side Cards for the presence of poker hands, blackjack hands, Magic Cards and/or any combination of the above for predetermined winning combinations and pay winning hands per a prescribed pay table. Bonuses can also be paid if the player is able to use all of the three Side Cards by placing them on the game board. Bonuses can be issued in the form of credits (i.e. monetary pay outs, free turns of the Side Cards, extra selections in the bonus round and/or any other form of suitable value).

In certain platforms, the computer program will allow the player to use the first of the three exposed Side Cards in the game by way of a touch screen interface whereby the player moves the card to the appropriate space on the game board. The rules of traditional solitaire will govern the play of the Side Cards as Well as all cards on the game board.

If the player is able to use the first of the Side Cards by placing it on the game board, they are allowed to try and use the second of the three cards, and so on. This is by convention as only the top exposed Side Card can be used on the game board. If the top exposed Side Card cannot be played, the player will need to place another wager or use credits to expose the next three Side Cards. Alternate embodiments can be used to allow the player to forgo placing an additional wager to see the next three Side Cards. These may include, but are not limited to scenarios where the player is able to place all three previous Side Cards on the game board. In this case, the player could see the next three Side Cards for free (i.e. without placing an additional wager) and still qualify for a bonus. These steps are repeated until the player exposes the final three Side Cards.

If a Magic Card is revealed in the Side Cards, the player may also be given a free turn of the Side Cards. More free turns can be given if more Magic Cards are revealed, whereby if the player has two Magic Cards in the set of three cards the player may be given two free turns of the Side Cards, and three free turns respectively with the presence of three Magic Cards.

After the player completes a pass through the stack of Side Cards, the computerized method will restart the play of the Side Cards by beginning with the first three cards which remain in the Side Card pile. Per the preferred embodiment, the Side Cards will not be reshuffled but will remain in the same order resulting, from the play of the Side Cards as above. This is consistent with the traditional rules of solitaire and is necessary as if the remaining Side Cards were continually shuffled the game would be much easier to win and require different strategies. However, modifications to the play of the Side Cards are contemplated, such as randomizing the cards after each round for play based on certain wagering paradigms. Further, if the player has exhausted all moves via play of the Side Cards, an embodiment may include the option for the player to place an additional wager to randomize the Side Cards and allow at least one round of play of the Side Cards as per the methods described in steps detailed above. This may include continued payouts for bonuses on prescribed pay tables for poker and blackjack hands as described previously.

Throughout the play of the game described above the computer program will identify predetermined criteria that trigger a bonus round and a mechanism for playing the bonus round.

The following examples will be used to further demonstrate play of the game, In each case the game begins with a player inserting the mandatory monies or credits to start the game. Additionally it is assumed that players will be required to wager credits or monies to expose the Side Cards in groups of three, thereby allowing them to qualify for bonus payouts. In certain bonus situations or other embodiments players will not need to pay additional monies to see the next three Side Cards. For the sake of simplicity, the following discussion does not include the bonuses paid for Magic Cards, but these bonuses are described above.

### EXAMPLE

The player is dealt an initial game hand. The card in the first column is a 3 of diamonds, the exposed card in the second column is a 5 of diamonds, the exposed card in the third column is a King of clubs, the exposed card in the fourth column is a Queen of diamonds, the exposed card in the fifth column is an Ace of hearts, the exposed card in the sixth column is a 9 of diamonds, and the final exposed card in the seventh column is a Jack of clubs.

To begin the game, the computer program analyzes the cards for the presence of a poker hand based on the composition of the exposed cards. In this case, the player has drawn a flush with five of the seven cards being in the suit of diamonds. This is a winning poker hand and paid on a predetermined pay table. Standard winning poker hands may begin with at least a pair and include two pairs, three of a kind, straight, flush, straight flush, full house, four of a kind, and royal flush.

After the poker hand is paid in the form if credits or monies, the player will be able to make their moves. In this case, the player may move the Queen of diamonds in the fourth column and place it underneath the King of clubs in the third column. The computer reveals the card underneath the Queen of diamonds which is a 6 of hearts. The player may also place the Ace of hearts in the fifth column on the separate pile allocated for restacking the cards by moving the card to the appropriate Foundations area. Bonuses may be paid for uncovering Aces.

The computer then reveals the card underneath the Ace which is a 2 of hearts. The player moves this card and places it on top of the Ace of hearts in the Foundations stack. The computer reveals the card underneath the 2 of hearts which is a King of hearts. At this point the player has no more moves with their originally dealt cards and must use the Side Cards to continue.

Since the player in this example has exhausted all moves available in the Tableau arising from The original game hand, the player now must reveal the Side Cards to continue the game. As per the preferred embodiment, the player will insert the required monies/credits to see the first three Side Cards analogous to putting in credits to spin reels on a slot machine. In this example, the first group of three Side Cards are an 8 of hearts, a 6 of spades, and a 7 of clubs in that order. These three cards are both a straight in poker (6, 7, and 8) and their combined sums: total 21, thereby giving the player a bonus payout. However, the player is not able to place the top card, the 8 of hearts, on the game board, thus they will have to insert additional monies/credits to see the next group of three Side Cards. This process will repeat until the player has exhausted all moves, moved into the bonus round, or has won the game.

Players can enter the bonus round by one of several methods. These methods are not exclusionary in nature, but represent possibilities for entrance into the bonus round. Other methods of triggering a bonus round are contemplated within the scope and spirit of the invention and are therefore not limited to the following list. A bonus round can be entered by receiving a predetermined poker hand on the exposed seven cards in the initial deal of the game. For example, if the player's first seven exposed cards (i.e. one card in each column) form a hand of a full house or better, this may trigger the bonus round. A bonus round can be entered by making a run of cards from King through two on the game board. A bonus round can be entered by making a predetermined number of initial moves using the originally dealt cards. For example, if a player is able to make seven individual moves with their initial cards this may allow them to enter the bonus round. A bonus round can be entered by winning the game by the method described above in which all 52 cards are arranged in ascending order (Ace through King) in each of the four suits in the Foundations region. A bonus round can be entered by revealing a predetermined number of Magic Cards whether in the Tableau portion of the game or the Side Cards. A bonus round can be entered by exposing all four Kings and having them placed on the game board. In the event the player moves to the bonus round during the play of the game, the game will resume at the place it left off after the bonus round is complete. Several Bonus rounds are contemplated of in the play of the game.

### Example Bonus Round 1

The object of a first contemplated bonus round will be to arrange the cards into four columns of King through 2. Aces will not be used in the bonus round to make runs, but will be present to allow players to win more by the methods described below. The bonus round begins with exposing a single King (red or black) atop a field of forty-eight unexposed cards.

The player will have a certain predetermined number of choices to expose cards in hopes of making a run of King through 2 using the traditional rides of solitaire (i.e. placing an opposite colored card of descending value underneath the exposed King, and repeating this process until all cards King through 2 are present in a run). If the player is unable to add subsequent cards to the King, this King will be out of play and the next of the three Kings will be displayed with the player facing similar rules and goals. This process is repeated until all four Kings are used.

Bonuses will he paid based on the length and number of runs a player is able to make, with the highest bonus paid for 4 runs of King through 2. In more detail, the player reaches the bonus round by a method described above. The player is presented with a new touch screen mandated and controlled by the same non-transitory computer medium as that described for the play of the main game. In this case, the player is shown a King of hearts or a red King and is allowed to make seven selections of unexposed cards to use under the King. If in the course if selecting their cards the player uncovers an Ace, they will be given more selections such as an additional three cards to uncover.

In this case (i.e. a red King) the player must uncover a black Queen (clubs or spades) to place under the red King. If the player is able to expose a red Queen they will then try to find a black Jack continuing on until they reach a black two. If the player runs out of moves, the column of cards that were used as well as the King will be removed from play, however the cards the player exposed will remain exposed for use in subsequent rounds.

In other variations, the cards that were used in the first round will be returned to play for use in the later rounds. The process will repeat until all four Kings are played. Each time the player is able to add a card to the run beginning with the King, the player will win bonus monies or credits. Higher payouts will be given for longer runs with the highest payout being a jackpot for making the four runs of King through two.

### Example Bonus Round 2

In a Second exemplary bonus round the 52 cards are presented face down on the bonus screen. The player is given a predetermined number of selections to find specific cards. For example the player may be given a fixed number of selections to uncover the Kings, whereby bonuses are paid for revealing cards other than Kings but the maximum bonus is paid when the Kings are discovered. A jackpot can be formulated if the player uncovers all 4 Kings. This bonus scheme is well-suited for a bonus round that is triggered when the player exposes all four Kings on the Tableau portion of play.

### Example Bonus Round 3

The player may enter into the bonus round whereby all 52 cards are presented face down as in bonus round 2 described above. In this case the player is also given a predetermined number of cards to uncover. The goal is to uncover cards that create a poker hand and/or cards that can be reconfigured into a solitaire hand. The player wins if the selected cards form poker hands, such as pairs, or if the cards are of alternating color and numerical denomination consistent with the traditional rules of solitaire. The computer program will be responsible for finding the best arrangement of the cards to provide the player with the maximum bonus.

### Alternative Bonus Scenarios

The above depiction of bonus rounds are but some limited examples by which players. can win additional monies in the game. Other methods of bonus rounds may be considered, such as turning over unexposed cards and calculating the pip total of the cards whereby the sum total of the pips would equal the number of bonus credits won. Tens, Jacks, Queens and Kings would have a pip total of ten.

A multiplier function can be created through the use of Aces which, when turned over, can multiply the total winnings by an exemplary ten times (10×). More Aces revealed can result in higher multipliers. Alternatively, uncovering Aces can allow for the selection of more cards than what would be standardly allowed in the bonus round.

Bonuses can also be paid for poker hands and or blackjack hands that occur in the process of uncovering cards. For example, if the player were to reveal three 8's followed by two 4's, this could be considered a full house and, in addition to the pip total of 28 (8+8+8±4±4=28), the player could receive an additional bonus for the full house. Similarly if the player revealed a 5, 6, 3, and 7 this would total 21 and another bonus can be paid.

Bonus rounds may also be paid with free “spins” of the Side Grids and/or deals of the Tableau portion of the game, such that the player will get bonuses based on a predetermined pa table similar to those described above. The number of free spins may be determined by the computer and/or may be contingent upon the player selecting an unexposed card from a grouping of cards and the number of free spins may be determined by the pip value of that card. The free spins will be independent of the Tableau and/or Foundation portion of the game, therefore the results of the free spins will only be used to pay bonuses.

The foregoing describes a method of play for a single person and the computer program to execute the steps in the game. It is also contemplated that the current invention methods of play may be applied to multiple players playing against the computer and/or two or more players playing head-to-head against each other or against groups of players playing against one another. In this manner, the present game methods are envisioned to readily adaptable to single-player games as well as to group or community gaming genres. More specifically, this disclosed invention is well suited as a community game where several gaming consoles are linked in a traditional casino environment through the computer program described herein. Though each player may be playing their own game, several methods exist by which to make a community experience. The methods include player consoles linked to: 1) transport all linked players to the bonus round when triggered by any one player; 2) Share in jackpots or bonuses attained through the presence of Magic Cards; and 3) Share Magic Cards. Other methods may also be implemented to link players together for a shared experience in the casino environment. Linking of players to challenge one another is a method by which the present game can he integrated into a social media format where games may be played for prizes or other unique rewards.

In a social media format play through a virtual medium or web hosting service can have one or more players using, the same deck of cards and random deal racing to see who can achieve certain goals such as revealing the most Magic Cards, finishing the game in the fastest time, or generating the highest score.

One-on-one or team play can also be envisioned through directing the computer medium to allow players to share cards or their screen and make play decisions in unison. Higher status or privileges on social sites can be achieved through monetary or other means whereby competitions can be developed. Players who are more skilled or have earned higher point rankings can be privy to more Magic Cards in a game or other such rewards. A plurality of options therefore exist through taking advantage of the novel aspects of the current invention to bring a social or community aspect to the traditional game of solitaire. Similarly, other methods not listed here are in the spirit of linking players together for a shared experience in the social media, mobile application driven, or internet spaces are within the scope of this invention as evident to those skilled in the art.

The foregoing invention has been described in accordance with the relevant legal standards, thus the description is exemplary rather than limiting in nature. Variations and modifications to the disclosed embodiment may become apparent to those skilled in the art and fall within the scope of the invention. For example, although the preceding description has been based on Klondike-style solitaire, the skilled artisan will appreciated that the principles of this invention can be applied to any of the other forms of solitaire with minimal adaption. For instance, instead of Klondike-style solitaire, this invention can be implemented in any of the well-known variants including, but not limited to. Pyramid solitaire, Golf solitaire, Yukon solitaire, Poker solitaire, Accordion solitaire. Canfield solitaire, Good Measure solitaire, Baker's Dozen solitaire, Spider solitaire and the like.

What is claimed is:

1. An electronically implemented method of playing a wagering game based on solitaire using images of playing cards, comprising the steps of:
providing an electronic gaming machine including at least one display screen configured to display images of playing cards, the electronic gaming machine including a non-transitory computer readable medium coded with instructions and executed by a processor to perform the steps of:
providing electronically producible images of one at least one standard deck of fifty-two playing cards with respective faces designated in ascending numerical sum 2-10, J, Q, K, A each in four suits,
accepting a primary wager from the player,
randomizing the deck of cards,
dealing the player an initial hand from the randomized deck of cards by placing some cards in a Tableau area and the remainder of the cards in a Side Cards area,
exposing some of the cards in the Tableau while all other cards in the Tableau are face-down,
placing the Side Cards face-down in a stack,
interacting with the player to play the initial hand according to the rules of solitaire in which at least some of the Tableau cards and some of the Side Cards are exposed while attempting to place all cards in mimetically ascending and suited columns in a Foundations area of the display screen,
and awarding the player a value if at least one exposed card matches a predetermined criteria.

2. The method of claim 1 wherein said interacting step includes turning over three cards face-up from the Side Cards, and said step of awarding the player is satisfied when the numerical sum of the three face-up Side Cards is twenty-one.

3. The method of claim 1 wherein said interacting step includes turning over three cards face-up from the Side Cards, and said step of awarding the player is satisfied when the three face-up Side Cards include at least one poker pair.

4. The method of claim 1 wherein said interacting step includes turning over three. cards face-up from the Side Cards, and said step of awarding the player is satisfied when the three face-up Side Cards form a poker straight.

5. The method of claim 1 wherein said interacting step includes turning over three cards face-up from the Side Cards, and said step of awarding the player is satisfied when the three face-up Side Cards form a poker flush.

6. The method of claim 1 wherein said step of awarding the player is satisfied when the exposed cards in the Tableau form at least one poker pair.

7. The method of claim 1 wherein said step of awarding the player is satisfied when the exposed cards in the Tableau form at least a five-card poker straight.

8. The method of claim 1 wherein said step of awarding the player is satisfied when the exposed cards in the Tableau form at least a five-card poker flush.

9. The method of claim 1 wherein said step of awarding the player is satisfied when the exposed cards in the Tableau form at least a five-card full house.

10. The method of claim 1 wherein said step of awarding the player is satisfied when at least one predetermined Magic Card is exposed in the Tableau.

11. The method of claim 1 wherein said interacting step includes turning over three cards face-up from the Side Cards, and said step of awarding the player is satisfied when at least one predetermined Magic Card is exposed among the three face-up Side Cards.

12. The method of claim 1 wherein said step of awarding the player is satisfied when at least two predetermined Magic Cards are exposed in the predetermined sequence in the Tableau.

13. The method of claim 1 wherein said interacting step includes turning over three cards face-up from the Side Cards, and said step of awarding the player is satisfied when at least two predetermined Magic Cards are exposed in the predetermined sequence among the three face-up Side Cards.

14. The system of claim 1, wherein said step of awarding the player a value includes issuing a monetary credit.

15. The system of claim 1, wherein said step of awarding the player a value includes activating a game bonus event.

16. The system of claim 1, wherein said step of dealing the player an initial hand includes distributing twenty-eight Tableau cards and twenty-four Side Cards, and arranging the Tableau cards into seven columns, wherein the first column has one card, the second column has two cards, the third column has three cards, the fourth column has four cards, the fifth column has five cards, the sixth column has six cards and the seventh column has seven cards.

17. An electronically implemented method of playing a wagering game similar to Klondike-style solitaire using images of playing cards, comprising the steps of:
providing an electronic gaining machine including at least one display screen configured to display images of playing cards, the electronic gaining machine including a non-transitory computer readable medium coded with instructions and executed by a processor to perform the steps of:
providing electronically producible images of one standard deck of fifty-two playing, cards with respective faces designated in ascending numerical sum 2-10, J, Q, K, A each in four suits,
accepting a primary wager from the player,
randomizing the deck of cards,
dealing the player an initial hand from the randomized deck of cards consisting essentially of twenty-eight Tableau cards and twenty-four Side Cards,
arranging the Tableau cards into seven columns, wherein the first column has one card, the second column has two cards, the third column has three cards, the fourth column has four cards, the fifth column has five cards, the sixth column has six cards and the seventh column has seven cards,
exposing the top card of each column while all other cards in the Tableau are face-down,
placing the Side Cards face-down in a stack,
interacting with the player to play the initial hand according to the rules of Klondike-style solitaire in which at least seven of the Tableau cards and all of the Side Cards are exposed while attempting to place all fifty-two cards in four numerically ascending and suited columns in a Foundations area of the display screen, said interacting step includes turning over three cards face-up from the Side Cards,
and awarding the player a value if at least one exposed card matches a predetermined criteria, said step of awarding the player is satisfied when at least one of the following predetermined criteria occurs: the numerical sum of the three face-up Side Cards is twenty-one, the three face-up Side Cards include at least one poker pair, the three face-up Side Cards form a poker straight, the three face-up Side Cards form a poker flush, the seven exposed cards in the Tableau form at least one poker pair, the seven exposed cards in the Tableau form at least a five-card poker straight, the seven exposed cards in the Tableau form at least a five-card poker flush, the seven exposed cards in the Tableau form at least a five-card full house, at least one predetermined Magic Card is exposed in the Tableau, and at least one predetermined Magic Card is exposed among the three face-up Side Cards, at least two predetermined Magic Cards are exposed in the predetermined sequence in the Tableau, and at least two predetermined Magic Cards are exposed in the predetermined sequence among the three face-up Side Cards.

18. A solitaire gaming system comprising: at least one input device; at least one display device; at least one processor; and at least one memory device storing a plurality of instructions, which when executed by the at least one processor, cause the at least one processor to operate with the at least one input device and the at least one display device for a play of a solitaire game using cards to:
provide electronically producible images of at least one standard deck of fifty-two playing cards with respective faces designated in ascending numerical sum 2-10, J, Q, K, A each in four suits,
accept a primary wager from the player,
randomize the deck of cards,
deal the player an initial hand from the randomized deck of cards by placing some card in a Tableau area and the remainder of the cards in a Side Cards area,
expose some of the cards in the Tableau while all other cards in the Tableau are face-down,
place the Side Cards faze-down in a stack,
interact with the player to play the initial hand according to the rules of solitaire in which at least some of the Tableau cards and some of the Side Cards are exposed while attempting to place all cards in numerically ascending and suited columns in a Foundations area of the display screen,
and award the player a value if at least one exposed card matches a predetermined criteria.

19. The system of claim 15, wherein said least one display device includes a touch-screen interface.

20. The system of claim 15, wherein said value comprises at least one of a monetary credit and a game bonus event.
